(19) United States
(12) Patent Application Publication
(10) Pub. No.: US 2025/0306507 A1
(43) Pub. Date: Oct. 2, 2025

(54) FIXING DEVICE AND RECORDING MEDIUM FLOATING DEVICE

(71) Applicant: FUJIFILM Business Innovation Corp., Tokyo (JP)

(72) Inventor: Yasuki TANAKA, Kanagawa (JP)

(73) Assignee: FUJIFILM Business Innovation Corp., Tokyo (JP)

(21) Appl. No.: 18/815,878

(22) Filed: Aug. 27, 2024

(30) Foreign Application Priority Data
Mar. 26, 2024 (JP) 2024-049503

(51) Int. Cl. G03G 15/20; G03G 15/00

(52) U.S. Cl. CPC G03G 15/2021; G03G 15/2064; G03G 15/6529; G03G 2215/2006

(57) ABSTRACT

A fixing device includes a transport section that grasps a leading edge part of a recording medium and transports the recording medium, a heating part that heats, in a non-contact manner, a surface of the recording medium on which an unfixed image is formed, the recording medium being transported by the transport section, and an air discharge part that is disposed at a position facing the heating part across a transport path along which the recording medium is transported, and that discharges air toward the transport path, in which the air discharge part includes a housing that defines the air discharge part, the housing including a surface-perforated plate portion in which multiple ventilation holes for discharging air toward the transport path are formed, and an air supply unit that supplies air to an inside of the housing through an air inlet formed in the housing, and an internal pressure of the housing is made higher than an atmospheric pressure by the air supplied from the air supply unit, and the air is discharged toward the transport path through the ventilation holes of the surface-perforated plate portion.

### CROSS-REFERENCE TO RELATED APPLICATIONS

This application is based on and claims priority under 35 USC 119 from Japanese Patent Application No. 2024-049503 filed Mar. 26, 2024.

### BACKGROUND

### (i) Technical Field

The present invention relates to a fixing device and a recording medium floating device.

### (ii) Related Art

There is known an image forming apparatus including a fixing device that heats, with radiant heat, a sheet-shaped recording medium on a surface of which an unfixed toner image is formed while floating and transporting the sheet-shaped recording medium. In JP2020-122932A, a heater is disposed above a transport path along which a recording medium is transported, and a blowing unit having a plurality of fans is disposed below the transport path. The recording medium is heated by the heater and is floated by an upward airflow generated by the fans of the blowing unit.

### SUMMARY

A configuration of a device that floats a recording medium being transported needs to be simple. Aspects of non-limiting embodiments of the present disclosure relate to a fixing device that includes a recording medium floating device with a simple configuration.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present invention, there is provided a fixing device including a transport section that grasps a leading edge part of a recording medium and transports the recording medium, a heating part that heats, in a non-contact manner, a surface of the recording medium on which an unfixed image is formed, the recording medium being transported by the transport section, and an air discharge part that is disposed at a position facing the heating part across a transport path along which the recording medium is transported, and that discharges air toward the transport path, in which the air discharge part includes a housing that defines the air discharge part, the housing including a surface-perforated plate portion in which a plurality of ventilation holes for discharging air toward the transport path are formed, and an air supply unit that supplies air to an inside of the housing through an air inlet formed in the housing, and an internal pressure of the housing is made higher than an atmospheric pressure by the air supplied from the air supply unit, and the air is discharged toward the transport path through the ventilation holes of the surface-perforated plate portion.

### BRIEF DESCRIPTION OF THE DRAWINGS

Exemplary embodiment(s) of the present invention will be described in detail based on the following figures, wherein:

FIG. 1 is a diagram showing a schematic configuration of an image forming apparatus;

FIG. 2 is an exploded perspective view showing a schematic configuration of a floating device;

FIG. 3 is a diagram showing a cross section of the floating device that is orthogonal to a transport direction of a recording medium;

FIG. 4 is a diagram showing a cross section of a floating device according to another aspect;

FIG. 5 is a diagram showing a shape of an internal perforated plate;

FIG. 6 is a diagram showing a shape of an internal perforated plate according to another aspect;

FIG. 7 is a diagram describing an aspect in which a surface-perforated plate and an internal perforated plate having a common shape are used;

FIG. 8 is a diagram describing an aspect in which a surface-perforated plate and an internal perforated plate having a common shape are used;

FIG. 9 is a diagram showing another aspect of a housing of the floating device;

FIG. 10 is a diagram showing a cross section of a floating device according to still another aspect;

FIG. 11 is a diagram showing a shape of a rear chamber partition plate;

FIG. 12 is a diagram showing a cross section of a floating device according to still another aspect; and

FIG. 13 is a diagram showing the internal perforated plate and a heat sink member.

### DETAILED DESCRIPTION

Hereinafter, an image forming apparatus 10 according to an exemplary embodiment of the present invention, particularly a fixing device and a recording medium floating device, will be described with reference to the drawings.

The image forming apparatus 10 is an electrophotographic image forming apparatus that forms a toner image on a recording medium P and that fixes the toner image. The recording medium P is typically a sheet-like member, particularly paper. The image forming apparatus 10 includes an accommodation section 12 that accommodates the recording medium P before image formation, a discharge section 14 from which the recording medium P after image formation is discharged, a transport section 16 that sends the recording medium P from the accommodation section 12 to the discharge section 14, an image forming section 18 that forms a toner image on the recording medium P during the transport process, and a fixing section 20 that heats and fixes the toner image on the recording medium P. Further, the image forming apparatus 10 may include one or both of a cooling section 22 that cools the recording medium P heated by the fixing section 20 and a reversing mechanism 24 that reverses front and back sides of the recording medium P with an image formed on a front surface so as to form an image on a back surface and that sends the reversed recording medium P to the image forming section 18 again. In addition to the toner image, an inkjet image formed by an inkjet may be used. In this case, the fixing includes drying via heating to stabilize an inkjet image in an unstable state.

The accommodation section 12 includes a plurality of supply trays 26 for accommodating stacked recording media P. The plurality of supply trays 26 may accommodate recording media of different sizes. The recording medium P is selectively fed from the plurality of supply trays 26 by the transport section 16.

The discharge section 14 includes a discharge tray 28 that receives the recording medium P on which an image has been formed and which has been cooled by the cooling section 22, and the recording media P are sequentially stacked on the discharge tray 28.

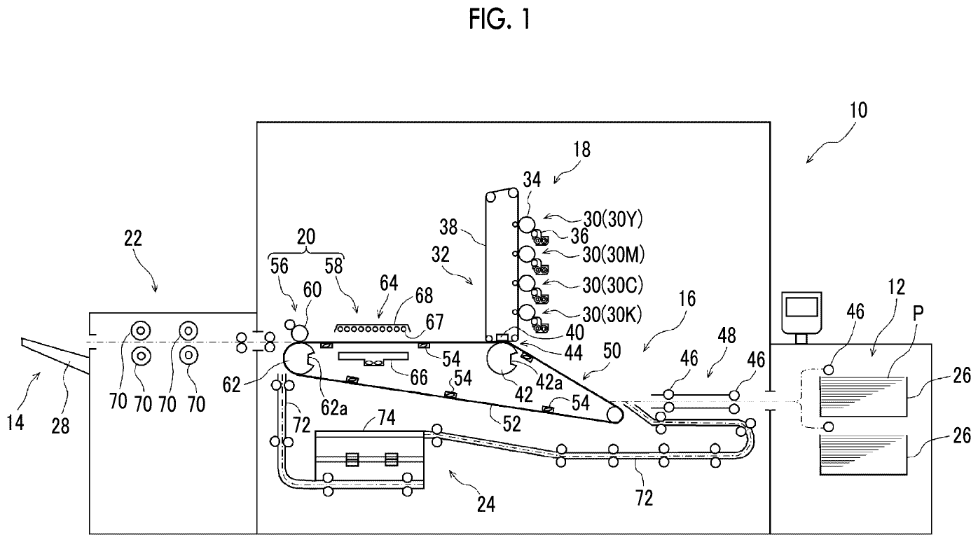

The image forming section 18 includes a toner image forming unit 30 that forms a toner image and a transfer unit 32 that transfers the formed toner image onto the recording medium P. The toner image forming unit 30 includes a photoreceptor drum 34 on which an electrostatic latent image is formed, and a developing device 36 that develops the electrostatic latent image on the photoreceptor drum 34 with toner. The toner image forming unit 30 is provided for each color, and in the image forming apparatus 10 shown in the drawing, four toner image forming units are provided corresponding to four colors of yellow (Y), magenta (M), cyan (C), and black (K). In FIG. 1, the toner image forming units 30 corresponding to the respective colors are indicated by reference numerals “30Y”, “30M”, “30C”, and “30K”. The transfer unit 32 includes a transfer belt 38 onto which the toner image on the photoreceptor drum 34 is transferred. The toner images formed by the toner image forming units 30 of the respective colors are primarily transferred onto the transfer belt 38 in a superimposed manner. The toner images transferred onto the transfer belt 38 are transported to a nip 44 formed between a transfer machine 40 and a facing roll 42 by movement of the transfer belt 38. In the nip 44, the transfer belt 38 is sandwiched between the transfer machine 40 and the facing roll 42 together with the recording medium P transported by the transport section 16. In the nip 44, the toner images on the transfer belt 38 are secondarily transferred onto the recording medium P. The transfer belt 38 is an intermediate transfer member that receives the toner image formed on the photoreceptor drum 34 and that delivers the toner image to the recording medium P.

The transport section 16 includes a roll transport section 48 that takes out and transports the recording medium P accommodated in the accommodation section 12 using a plurality of transport rolls 46, and a chain gripper 50 that grasps a leading edge of the recording medium P and transports the recording medium P. The roll transport section 48 sends the recording medium P via the rotating transport rolls 46 disposed on a transport path defined by a guide. The roll transport section 48 transports the recording medium P until the recording medium P is delivered to the chain gripper 50. The chain gripper 50 includes a pair of endless chains 52 disposed on both right and left sides of the path along which the recording medium P is transported, and grippers 54 disposed to be stretched across the chains 52 on the right and left sides to grasp the leading edge of the recording medium P. Each of the grippers 54 includes an elongated member that is stretched across the chains 52 on the right and left sides, and a plurality of claw members arranged along the elongated member. The leading edge of the recording medium P is grasped by the elongated member and the claw members. The grippers 54 are disposed on the chain 52 at predetermined intervals. The grippers 54 move along the path with the movement of the chain 52. The recording medium P whose leading edge is grasped by the grippers 54 is transported by being pulled by the moving gripper 54. Since the recording medium P is transported by being pulled by the grippers 54, the recording medium P is prevented from coming into contact with a feeding member such as a transport roll for sending the recording medium P or a guide member for defining the path. In order to avoid interference between the gripper 54 and the facing roll 42 during the moving process of the gripper 54, a recess 42a is formed in the facing roll 42.

The fixing section 20 includes a main heating part 56 that sandwiches the recording medium P onto which the toner image is transferred and that heats the recording medium P to fix the toner image onto the recording medium P, and a pre-heating part 58 that heats the recording medium P and the toner image on the recording medium P in a non-contact manner before the heating by the main heating part 56. The main heating part 56 includes a heating roll 60 that comes into contact with a surface of the recording medium P on which the toner image is formed and that heats the recording medium P, and a pressing roll 62 that presses the recording medium toward the heating roll 60. The pressing roll 62 is also formed with a recess 62a to avoid interference with the gripper 54, as with the facing roll 42 of the transfer unit 32. The pre-heating part 58 includes a heating part 64 disposed to face a surface of the recording medium P being transported onto which the toner image is transferred, and a floating device 66 disposed to face the heating part 64 across the transport path. The heating part 64 includes a plurality of tubular or rod-like heating elements 67 and a reflecting plate 68 that reflects radiation from the heating elements 67 toward the transport path of the recording medium P. The heating element 67 may be an infrared heater. The floating device 66 blows an airflow from an upper surface toward the transport path, floats the recording medium P being transported, and stabilizes a posture of the recording medium P. Since the posture is stabilized, a distance of the recording medium P from the heating part 64 is stabilized, thereby suppressing heating unevenness. The floating device 66 is an air discharge part that discharges air toward the transport path. Details of the floating device 66 will be described below.

The cooling section 22 includes cooling rolls 70 that sandwich the recording medium P transported from the fixing section 20. The image forming apparatus 10 includes two sets of cooling rolls 70. The cooling roll 70 may be a hollow cylindrical tube made of aluminum and is cooled by cooling air flowing inside the cylindrical tube. The cooling roll 70 comes into contact with the recording medium P, thereby cooling the recording medium P that has been heated in the fixing section 20.

The reversing mechanism 24 includes a reversing transport path 72 along which the recording medium P that has passed through the fixing section 20 is transported, and a reversing device 74 provided in the middle of the reversing transport path 72. The reversing transport path 72 extends from an outlet of the recording medium P in the fixing section 20 to a position where the recording medium P is delivered from the roll transport section 48 to the chain gripper 50. The recording medium P, on which images are formed on both surfaces, is sent to the reversing device 74 through the reversing transport path 72 after an image is fixed onto one surface by the fixing section 20, and front and back sides of the recording medium P are reversed by the reversing device 74. The reversed recording medium P is sent to the delivery position of the chain gripper 50 along the reversing transport path 72. The reversed recording medium P is transported to the transfer unit 32 by the chain gripper 50, where a surface on which an image is not formed faces the transfer machine 40, and the toner image is transferred to this surface.

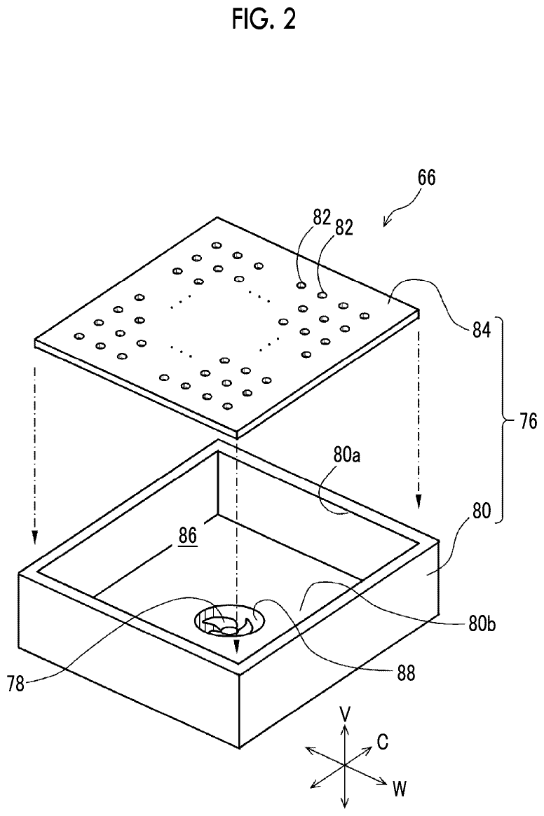

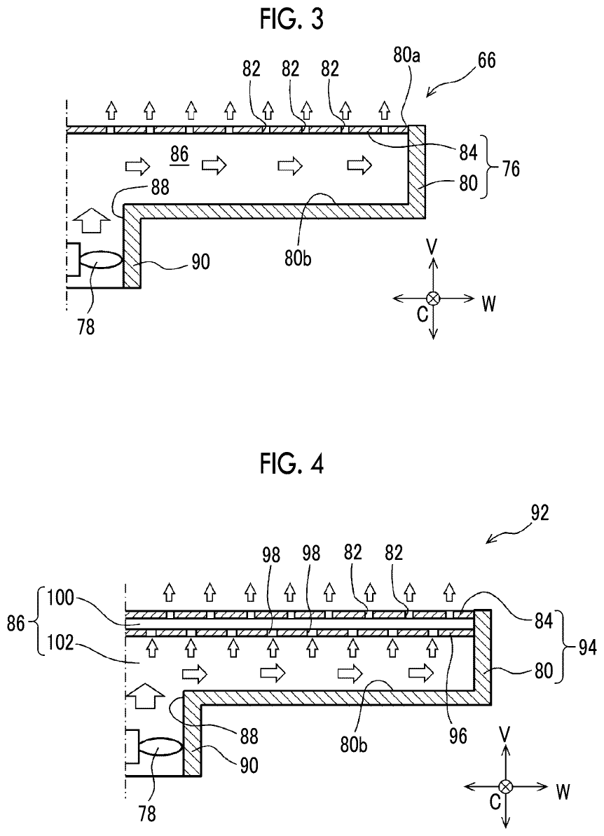

FIGS. 2 and 3 are diagrams showing a schematic configuration of the floating device 66, where FIG. 2 is an exploded perspective view and FIG. 3 is a diagram showing a cross section orthogonal to the transport direction of the recording medium P. Hereinafter, a direction orthogonal to the transport direction and the vertical direction will be referred to as a width direction, and the transport direction will be indicated by an arrow C, the vertical direction will be indicated by an arrow V, and the width direction will be indicated by an arrow W. FIG. 3 shows a right half of the diagram of the floating device 66, with a left half being symmetrical to the right half.

The floating device 66 includes a housing 76 through which an airflow is supplied to the transport path, and an air supply unit 78 that supplies air to the housing 76. A plurality of ventilation holes are formed on a surface of the housing 76 on the transport path side. More specifically, the housing 76 includes a substantially rectangular housing base 80 having an opening 80a on the transport path side, that is, on the upper side, and a surface-perforated plate 84 that is disposed to cover the opening 80a and that has a plurality of ventilation holes 82. The housing base 80 and the surface-perforated plate 84 are integrated to form a rectangular box-shaped housing 76, and cooperate to define an air supply chamber 86 inside the housing 76. The surface-perforated plate 84 forms a surface-perforated plate portion of the rectangular box-shaped housing 76. A surface of the housing base 80 facing the transport path, that is, the entire upper surface may be open. The surface-perforated plate 84 is disposed to face the heating part 64. The surface-perforated plate 84 is a flat plate with a substantially rectangular shape, and a dimension of the surface-perforated plate 84 in the width direction is determined according to a dimension of the largest recording medium P to be transported and may be 297 to 1000 mm. Each of the ventilation holes 82 may be circular and may have a diameter of 0.2 to 10 mm. The plurality of ventilation holes 82 may be distributed two-dimensionally, that is, in both the transport direction and the width direction, and may be arranged along each of the transport direction and the width direction. Alternatively, the plurality of ventilation holes 82 may be disposed at lattice points forming a lattice pattern composed of elements extending in the transport direction and elements extending in the width direction. The ventilation holes 82 may be arranged at a pitch of 20 to 200 mm along each of the transport direction and the width direction.

An air inlet 88 that receives the air from the air supply unit 78 is formed in the housing base 80. The air inlet 88 may be formed at a center of a bottom surface 80b of the housing base 80. The housing base 80 may include a duct portion 90 connected to the air inlet 88, and the air supply unit 78 may be disposed in the duct portion 90, and the air supply unit 78 supplies air to the air supply chamber 86. The air supply unit 78 may be an axial fan. In addition, air may be supplied from the air supply unit 78 disposed away from the housing base 80 via a separate duct. The air supplied by the air supply unit 78 is increased in pressure to a level exceeding an atmospheric pressure in the air supply chamber 86 and is discharged through the ventilation holes 82 toward the transport path. The airflow is indicated by a void arrow. In a case where the recording medium P is transported, an air layer is formed between the recording medium P and the surface-perforated plate 84, allowing the recording medium P to be supported in a non-contact manner. Air may be supplied to the housing 76 from a single air supply unit 78. An area of the surface-perforated plate 84 is larger than an area of the air inlet 88, and the housing 76 discharges air to an area larger than the air inlet 88 through which the air is received.

The surface-perforated plate 84 may be made of aluminum. As a result, the temperature rise of the surface-perforated plate 84 due to radiation from the heating part 64 is suppressed as compared with a case where the surface-perforated plate 84 is made of resin. In addition, a reflectance of a surface of the surface-perforated plate 84 that faces the heating part 64 with respect to infrared rays may be set to 80% or more.

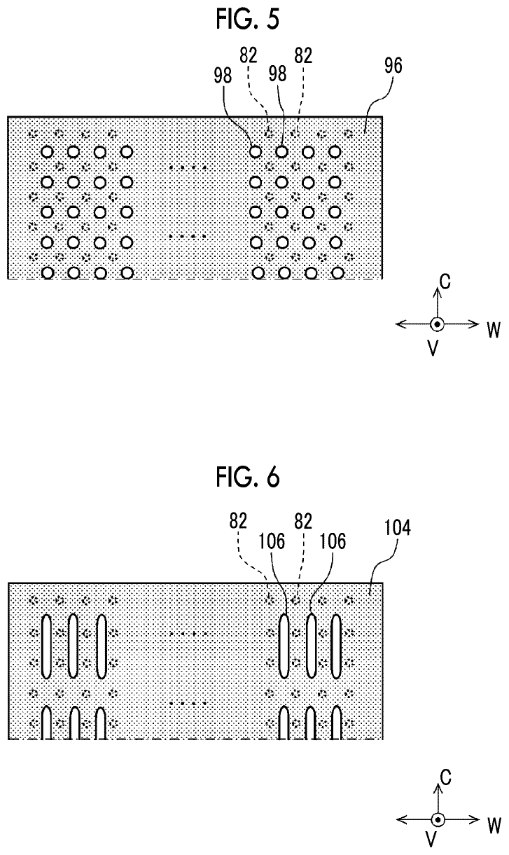

FIGS. 4 and 5 are diagrams showing other examples of the floating device. FIG. 4 is a diagram showing a cross section orthogonal to the transport direction of the recording medium P, as with FIG. 3, and FIG. 5 is a diagram showing an additional perforated plate. A floating device 92 shown in FIG. 4 is different from the floating device 66 in the internal configuration of the housing. The same components as the components of the floating device 66 are denoted by the identical reference numerals, and descriptions thereof will be omitted. The floating device 92 is an air discharge part that discharges air toward the transport path.

The floating device 92 includes an internal perforated plate 96 disposed in the air supply chamber 86. The internal perforated plate 96 is a flat plate with a substantially rectangular shape. A plurality of ventilation holes 98 are formed in the internal perforated plate 96. The internal perforated plate 96 partitions the air supply chamber 86 into a front chamber 100 on the surface-perforated plate 84 side and a rear chamber 102 on a side opposite to the front chamber 100, that is, on the bottom surface 80b side of the housing. An outer shape of the internal perforated plate 96 may identical to an outer shape of the surface-perforated plate 84 and may be disposed parallel with the surface-perforated plate 84.

An interval between the surface-perforated plate 84 and the internal perforated plate 96 may be narrower than an interval between the internal perforated plate 96 and the bottom surface 80b of the housing. For example, the interval between the surface-perforated plate 84 and the internal perforated plate 96 may be between 1/20 and ½ of the interval between the internal perforated plate 96 and the bottom surface 80b of the housing, or may be between 1/20 and 1/10 of the interval between the internal perforated plate 96 and the bottom surface 80b of the housing. The interval between the internal perforated plate 96 and the bottom surface 80b of the housing may be 10 to 100 mm, and in this case, the interval between the surface-perforated plate 84 and the internal perforated plate 96 may be 0.5 to 5 mm.

The air supplied by the air supply unit 78 flows within the rear chamber 102 from the central air inlet 88 toward the periphery. The air flows to the front chamber 100 through any of the ventilation holes 98 of the internal perforated plate 96 in the process of flowing toward the periphery within the rear chamber 102, and is discharged toward the transport path through the ventilation holes 82 of the surface-perforated plate 84. In the case where the internal perforated plate 96 is not provided, the air flowing toward the periphery within the air supply chamber 86 is heated by the surface-perforated plate 84, which has been raised in temperature by the radiation from the heating part 64, during this process. Therefore, a peripheral part of the surface-perforated plate 84 tends to have a high temperature. On the other hand, in a case where the internal perforated plate 96 is provided, the air flowing from the center toward the periphery within the rear chamber 102 does not come into contact with the surface-perforated plate 84, which has been raised in temperature. As a result, the temperature rise during the process of sending the air to the periphery is suppressed. Therefore, the air sent to the front chamber 100 through the ventilation holes 98 of the internal perforated plate 96 has a lower temperature even at a peripheral part as compared with a case where the internal perforated plate 96 is not provided. Therefore, low-temperature air whose temperature rise is suppressed is supplied to the surface-perforated plate 84, and the occurrence of temperature unevenness in the surface-perforated plate 84 is suppressed.

In FIG. 5, the internal perforated plate 96 is shown, and positions of the ventilation holes 82 in the surface-perforated plate 84 are indicated by broken lines. A shape of the ventilation hole 98 of the internal perforated plate 96 may be circular, and a diameter of the ventilation hole 98 may be equal to or greater than a diameter of the ventilation hole 82 of the surface-perforated plate 84 or may be greater than the diameter of the ventilation hole 82 of the surface-perforated plate 84. Furthermore, the diameter of the ventilation hole 98 of the internal perforated plate 96 may be 1 to 5 times or 1 to 2 times the diameter of the ventilation hole 82 of the surface-perforated plate 84. The ventilation holes 98 of the internal perforated plate 96 may be distributed two-dimensionally and may be arranged along each of the transport direction and the width direction. Alternatively, the plurality of ventilation holes 98 of the internal perforated plate 96 may be disposed at lattice points forming a lattice pattern composed of elements extending in the transport direction and elements extending in the width direction. The ventilation holes 98 may be arranged at a pitch of 20 to 200 mm along the transport direction and the width direction. Positions of the ventilation holes 98 of the internal perforated plate 96 as seen in a plan view may be different from positions of the ventilation holes 82 of the surface-perforated plate 84. With this arrangement, the air discharged from the ventilation holes 98 of the internal perforated plate 96 first hits the surface-perforated plate 84, flows along the surface-perforated plate 84, and then is finally discharged from the ventilation holes 82. In a case where the ventilation holes 82 of the surface-perforated plate 84 are disposed at the lattice points, the ventilation hole 98 of the internal perforated plate 96 may be located at an intersection of diagonals of the smallest lattice formed by the ventilation holes 82. A part of the ventilation holes 98 of the internal perforated plate 96 may be disposed at a position different from the positions of the ventilation holes 82 of the surface-perforated plate 84, or all of the ventilation holes 98 of the internal perforated plate 96 may be disposed at positions different from the positions of the ventilation holes 82 of the surface-perforated plate 84. The internal perforated plate 96 is a dispersion plate that disperses and supplies the air sent from the air supply unit 78 to the center of the air supply chamber 86 toward a surface of the surface-perforated plate 84 on the side opposite to the transport path.

FIG. 6 is a diagram showing another aspect of the internal perforated plate. In FIG. 6, positions of the ventilation holes 82 of the surface-perforated plate 84 are indicated by broken lines. An internal perforated plate 104 is used in place of the internal perforated plate 96 of the floating device 92 shown in FIG. 4. The internal perforated plate 104 has ventilation holes 106 in a slit shape. A width of the slit-shaped ventilation hole 106 may be equal to or greater than the diameter of the ventilation hole 82 in the surface-perforated plate 84. The individual slit-shaped ventilation holes 106 may be disposed to extend along the transport direction. Positions of the ventilation holes 106 of the internal perforated plate 104 as seen in a plan view may be disposed so as not to overlap positions of the ventilation holes 82 of the surface-perforated plate 84. With this arrangement, the air discharged from the ventilation holes 106 of the internal perforated plate 104 first hits the surface-perforated plate 84, flows along the surface-perforated plate 84, and then is discharged from the ventilation holes 82. The slit-shaped ventilation holes may extend in a direction other than the transport direction, for example, in the width direction. In addition, a plurality of slit-shaped ventilation holes extending in different directions may be formed. The internal perforated plate 104 is a dispersion plate that disperses and supplies the air sent from the air supply unit 78 to the center of the air supply chamber 86 toward a surface of the surface-perforated plate 84 on the side opposite to the transport path.

The shape of the ventilation hole of the internal perforated plate may be other than a circle or a slit shape. For example, the shape may be triangular, quadrangular, or cross-shaped.

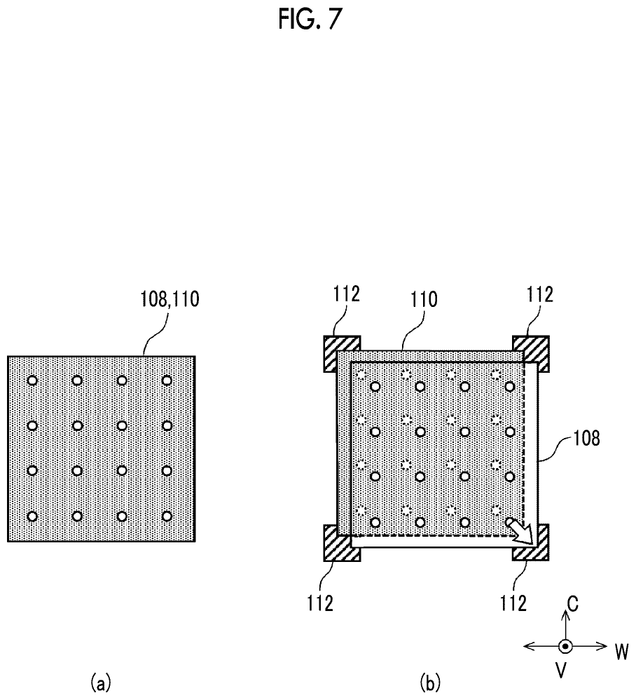

FIG. 7 is a schematic diagram showing another aspect of the surface-perforated plate and the internal perforated plate. A part (a) in FIG. 7 shows shapes of a surface-perforated plate 108 and an internal perforated plate 110, and a part (b) in FIG. 7 shows a state in which the surface-perforated plate 108 and the internal perforated plate 110 are incorporated into a housing 94. The surface-perforated plate 108 and the internal perforated plate 110 have the identical shape and are interchangeable. The surface-perforated plate 108 is disposed to be displaced in a lower right direction relative to the internal perforated plate 110 in FIG. 7, whereby positions of the respective ventilation holes are displaced. Positioning blocks 112 are configured to position and support four corners of the surface-perforated plate 108 and the internal perforated plate 110. At corners that cannot be supported by the positioning blocks 112, such as an upper left corner of the surface-perforated plate 108 shown in the part (b) in FIG. 7, the surface-perforated plate 108 is supported by using a spacer disposed between the surface-perforated plate 108 and the internal perforated plate 110. A peripheral edge of the surface-perforated plate 108 and a peripheral edge of the internal perforated plate 110 are sealed to ensure there is no gap with a side surface of the housing. The surface-perforated plate 108 forms a surface-perforated plate portion of the housing. The internal perforated plate 110 is a dispersion plate that disperses and supplies the air sent from the air supply unit 78 to the center of the air supply chamber 86 toward a surface of the surface-perforated plate 84 on the side opposite to the transport path.

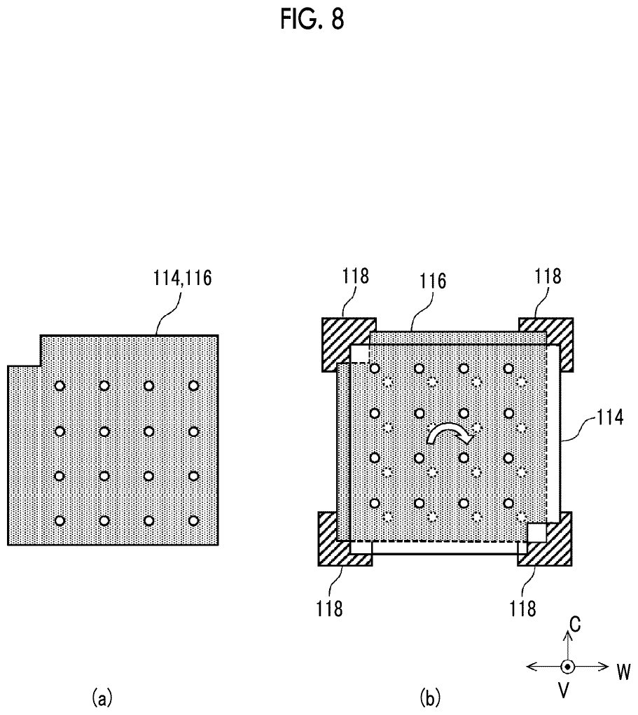

FIG. 8 is a schematic diagram showing still another aspect of the surface-perforated plate and the internal perforated plate. A part (a) in FIG. 8 shows shapes of a surface-perforated plate 114 and an internal perforated plate 116, and a part (b) in FIG. 8 shows a state in which the surface-perforated plate 114 and the internal perforated plate 116 are incorporated into the housing 94. The surface-perforated plate 114 and the internal perforated plate 116 have the identical shape and are interchangeable. The surface-perforated plate 114 is disposed in a state where an orientation is changed by rotating by 180° relative to the internal perforated plate 116, whereby positions of the respective ventilation holes are displaced. Positioning blocks 118 are configured to position and support four corners of the surface-perforated plate 114 and the internal perforated plate 116. As shown in the part (a) in FIG. 8, by cutting out one corner, the four corners of the surface-perforated plate 114 and the internal perforated plate 116 can be supported. A peripheral edge of the surface-perforated plate 114 and a peripheral edge of the internal perforated plate 116 are sealed to ensure there is no gap with a side surface of the housing. The surface-perforated plate 108 forms a surface-perforated plate portion of the housing. The internal perforated plate 116 is a dispersion plate that disperses and supplies the air sent from the air supply unit 78 to the center of the air supply chamber 86 toward a surface of the surface-perforated plate 84 on the side opposite to the transport path.

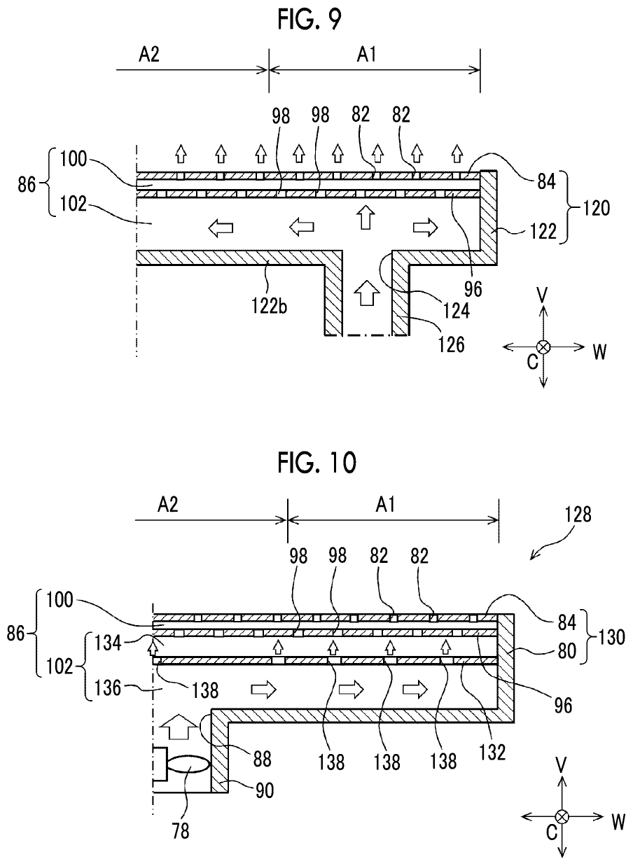

FIG. 9 is a schematic diagram showing another aspect of the housing. FIG. 9 is a diagram showing a cross section orthogonal to the transport direction of the recording medium P, as with FIGS. 3 and 4. The identical components to the components of the floating device 92 shown in FIG. 4 are denoted by the identical reference numerals, and descriptions thereof will be omitted. In a case where the recording medium P having a size that covers the entire width of the surface-perforated plate 84 is transported, the time during which the radiation from the heating part 64 is blocked by the recording medium P does not change between a central portion and end portions in the width direction. Therefore, the radiation received by the surface-perforated plate 84 does not change between the central portion and the end portions in the width direction. On the other hand, in a case where the recording medium P having a width smaller than the width of the surface-perforated plate 84 is transported, the end portions where the radiation from the heating part 64 is not blocked by the recording medium P receive more radiation than the central portion. Therefore, the temperature of the end portions of the surface-perforated plate 84 increases more than the temperature of the central portion. In a case where recording media P of different sizes are mixed and transported, the end portions in the width direction have a lower passing frequency of the recording medium P compared to the central portion. An area where the passing frequency of the recording medium P is low is referred to as a low passing frequency area A1, and an area where the passing frequency is high is referred to as a high passing frequency area A2. The high passing frequency area A2 may be determined based on a size of a recording medium that is frequently used among recording media that are smaller than the maximum size of the recording medium expected.

A housing base 122 of a housing 120 shown in FIG. 9 has an air inlet 124 formed in a portion of a bottom surface 122b corresponding to the low passing frequency area A1. A duct portion 126 connected to the air inlet 124 may be formed to branch so as to distribute an airflow from one air supply device to the air inlets 124 on the right and left sides. Since the air inlet 124 is located nearby, more air is sent to the region corresponding to the low passing frequency area A1 of the surface-perforated plate 84 than in a case where the air inlet is located at the central portion, resulting in better cooling of this portion. As a result, the temperature unevenness of the surface-perforated plate 84 is reduced. In addition, the amount of air supplied to the region of the rear chamber 102 corresponding to the low passing frequency area A1 is greater than in a case where the same amount of air is uniformly supplied throughout the rear chamber 102. The internal perforated plate 96 is a dispersion plate that disperses and supplies the air sent from the air supply device to the end portions of the air supply chamber 86 toward a surface of the surface-perforated plate 84 on the side opposite to the transport path.

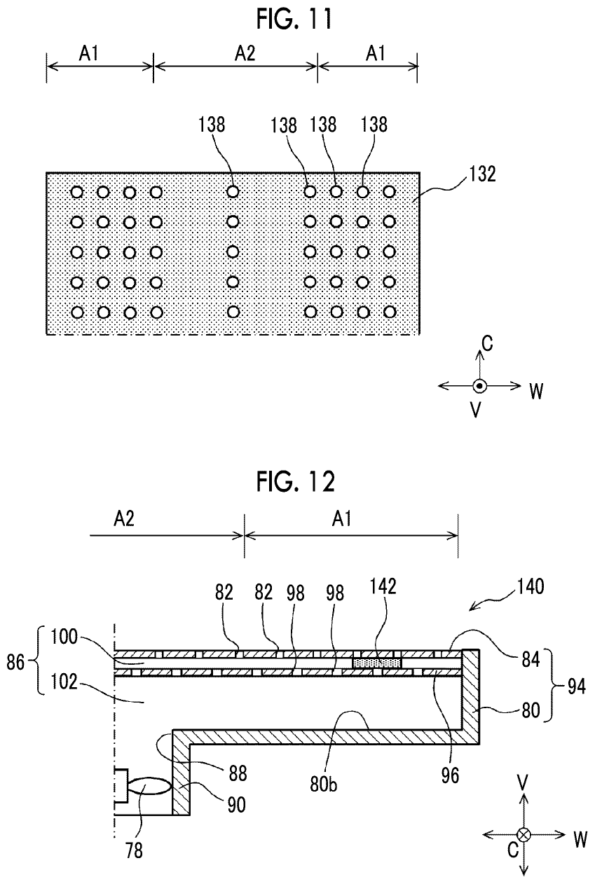

FIGS. 10 and 11 are diagrams showing other examples of the floating device. FIG. 10 is a diagram showing a cross section orthogonal to the transport direction of the recording medium P, as with FIGS. 3 and 4, and FIG. 11 is a diagram showing an additional perforated plate. A floating device 128 shown in FIG. 10 is different from the floating device 92 shown in FIG. 4 in the internal configuration of the housing. The same components as the components of the floating device 92 are denoted by the identical reference numerals, and descriptions thereof will be omitted. The floating device 128 is an air discharge part that discharges air toward the transport path.

The floating device 128 includes a rear chamber partition plate 132 within the housing 130 in addition to the surface-perforated plate 84 and the internal perforated plate 96. The rear chamber partition plate 132 partitions the rear chamber 102 into a rear anterior chamber 134 on the internal perforated plate 96 side and a rear posterior chamber 136 on the side opposite to the rear anterior chamber 134.

A plurality of ventilation holes 138 are formed in the rear chamber partition plate 132. A shape of each of the ventilation holes 138 is identical. The distribution of the ventilation holes 138 is not uniform. As shown in FIG. 11, the ventilation holes 138 are densely distributed in the low passing frequency area A1 and sparsely distributed in the high passing frequency area A2. The air supplied from the air inlet 88 to the rear posterior chamber 136 is sent to the rear anterior chamber 134 through the ventilation holes 138 of the rear chamber partition plate 132, and then passes through the internal perforated plate 116 and the surface-perforated plate 84 before being discharged to the transport path. Due to the above-described distribution of the ventilation holes 138 in the rear chamber partition plate 132, more air is sent to the low passing frequency area A1 of the surface-perforated plate 84 than in a case where the distribution of the ventilation holes 138 is uniform, resulting in better cooling of this portion. As a result, the temperature unevenness of the surface-perforated plate 84 is reduced. In addition, the amount of air supplied to the region of the rear anterior chamber 134 corresponding to the low passing frequency area A1 is greater than in a case where the same amount of air is uniformly supplied throughout the rear anterior chamber 134.

In the rear chamber partition plate 132, the air supply amount is made different depending on the density of the distribution of the ventilation holes 138 having the identical shape. Alternatively, the air supply amount may be made different by changing the shape and size of the ventilation holes. The air supply amount may be made different by changing the total area of the ventilation holes in the rear chamber partition plate 132 per predetermined area. An opening ratio that is a ratio of an area of the region of the rear chamber partition plate 132 corresponding to the low passing frequency area A1 to the sum of opening areas of all the ventilation holes in this region is made larger than an opening ratio that is a ratio of an area of the region corresponding to the high passing frequency area A2 to the sum of opening areas of all the ventilation holes in this region, thereby increasing the amount of air supplied to the low passing frequency area A1.

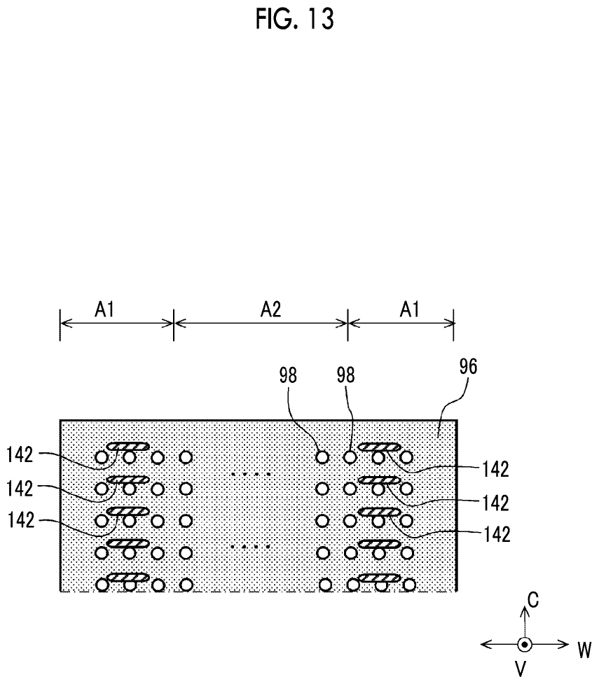

FIGS. 12 and 13 are diagrams showing other examples of the floating device. FIG. 12 is a diagram showing a cross section orthogonal to the transport direction of the recording medium P, as with FIGS. 3 and 4, and FIG. 13 is a diagram showing the internal perforated plate and a heat sink member.

A floating device 140 shown in FIG. 12 is different from the floating device 92 shown in FIG. 4 in that a heat sink member 142 is disposed between the surface-perforated plate 84 and the internal perforated plate 96. The floating device 140 is an air discharge part that discharges air toward the transport path. The heat sink member 142 is in contact with both the surface-perforated plate 84 and the internal perforated plate 96. The heat sink member 142 transfers heat from the surface-perforated plate 84 to the internal perforated plate 96, thereby contributing to lowering the temperature of the surface-perforated plate 84. The heat sink member 142 may be disposed to correspond to the low passing frequency area A1.

### Supplementary Note

(((1)))

A fixing device comprising:
a transport section that grasps a leading edge part of a recording medium and transports the recording medium;
a heating part that heats, in a non-contact manner, a surface of the recording medium on which an unfixed image is formed, the recording medium being transported by the transport section; and
an air discharge part that is disposed at a position facing the heating part across a transport path along which the recording medium is transported, and that discharges air toward the transport path,
wherein the air discharge part includes
   a housing that defines the air discharge part, the housing including a surface-perforated plate portion in which a plurality of ventilation holes for discharging air toward the transport path are formed, and
   an air supply unit that supplies air to an inside of the housing through an air inlet formed in the housing, and
an internal pressure of the housing is made higher than an atmospheric pressure by the air supplied from the air supply unit, and the air is discharged toward the transport path through the ventilation holes of the surface-perforated plate portion.
   (((2)))

The fixing device according to (((1))),
wherein the air discharge part includes an internal perforated plate that is disposed inside the housing to partition the inside of the housing into a front chamber on a surface-perforated plate portion side and a rear chamber on a side opposite to the front chamber, and in which a plurality of ventilation holes are formed, and the ventilation holes in at least a part of the internal perforated plate are disposed at positions different from positions of the ventilation holes of the surface-perforated plate portion, and
the air inlet is formed to open to the rear chamber.
   (((3)))

The fixing device according to (((2))),
wherein a distance between the surface-perforated plate portion and the internal perforated plate is narrower than a distance between the internal perforated plate and a bottom surface of the housing that faces the internal perforated plate.
   (((4)))

The fixing device according to (((2))) or (((3))),
wherein the ventilation holes of the surface-perforated plate portion and the ventilation holes of the internal perforated plate are circular, and a diameter of the ventilation holes of the internal perforated plate is larger than a diameter of the ventilation holes of the surface-perforated plate portion.
   (((5)))

The fixing device according to (((2))) or (((3))), wherein the ventilation holes of the surface-perforated plate portion are circular, the ventilation holes of the internal perforated plate are slit-shaped, and the ventilation holes of the internal perforated plate are disposed such that positions of the ventilation holes do not overlap the positions of the ventilation holes of the surface-perforated plate portion.

(((6)))

The fixing device according to (((2))) or (((3))),
wherein the ventilation holes of the surface-perforated plate portion and the ventilation holes of the internal perforated plate are circular, the surface-perforated plate portion and the internal perforated plate are plate members having an identical shape, and the ventilation holes of the surface-perforated plate portion and the ventilation holes of the internal perforated plate are located at different positions by shifting positions of the surface-perforated plate portion and the internal perforated plate or by changing orientations of the surface-perforated plate portion and the internal perforated plate.
   (((7)))

The fixing device according to any one of (((2))) to (((6))),
wherein an amount of air supplied to a region of the rear chamber corresponding to an area where a passing frequency of the recording medium is low is greater than in a case where the same amount of air is uniformly supplied throughout the rear chamber.
   (((8)))

The fixing device according to any one of (((2))) to (((6))),
wherein the air inlet formed in the housing is formed at a position, which corresponds to an area where a passing frequency of the recording medium is low, on a bottom surface of the housing that faces the internal perforated plate.
   (((9)))

The fixing device according to any one of (((2))) to (((6))),
wherein the air discharge part includes a rear chamber partition plate that is disposed in the rear chamber to partition the rear chamber into a rear anterior chamber on an internal perforated plate side and a rear posterior chamber on a side opposite to the rear anterior chamber, and in which a plurality of ventilation holes are formed, and
an opening ratio of the ventilation holes of the rear chamber partition plate is higher in a region corresponding to an area where a passing frequency of the recording medium is low than in a region corresponding to an area where a passing frequency of the recording medium is high.
   (((10)))

The fixing device according to any one of (((2))) to (((9))), further comprising:

a heat sink member that brings the surface-perforated plate portion and the internal perforated plate into thermal contact with each other in a region corresponding to an area where a passing frequency of the recording medium is low.

(((11)))

The fixing device according to any one of (((1))) to (((10))),
wherein the surface-perforated plate portion is made of aluminum.
   (((12)))

The fixing device according to (((11))),
wherein a reflectance of a surface of the surface-perforated plate portion that faces the heating part is 80% or more.
   (((13)))

The fixing device according to (((1))),
wherein the air discharge part includes a dispersion plate that is disposed parallel with the surface-perforated plate portion inside the housing and that disperses and supplies the air supplied from the air supply unit to a surface of the surface-perforated plate portion on a side opposite to the transport path.
   (((14)))

The fixing device according to any one of (((1))) to (((13))), further comprising:
a main heating part that heats and presses the recording medium after the heating by the heating part to fix the unfixed image.
   (((15)))

A recording medium floating device comprising:
a housing that is disposed at a position facing a heater heating, in a non-contact manner, a surface of a recording medium on which an unfixed image is formed across a transport path of the recording medium, the recording medium being grasped at a leading edge and transported, and that includes a surface-perforated plate portion in which a plurality of ventilation holes for discharging air toward the transport path are formed; and
an air supply unit that supplies air to an inside of the housing through an air inlet formed in the housing,
wherein an internal pressure of the housing is made higher than an atmospheric pressure by the air supplied from the air supply unit, and the air is discharged toward the transport path through the ventilation holes of the surface-perforated plate portion.
   (((16)))

The recording medium floating device according to (((15))),
wherein the recording medium floating device includes an internal perforated plate that is disposed inside the housing to partition the inside of the housing into a front chamber on a surface-perforated plate portion side and a rear chamber on a side opposite to the front chamber, and in which a plurality of ventilation holes are formed, and the ventilation holes in at least a part of the internal perforated plate are disposed at positions different from positions of the ventilation holes of the surface-perforated plate portion, and
the air inlet is formed to open to the rear chamber.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a transport section that grasps a leading edge part of a recording medium and transports the recording medium;
a heating part that heats, in a non-contact manner, a surface of the recording medium on which an unfixed image is formed, the recording medium being transported by the transport section; and
an air discharge part that is disposed at a position facing the heating part across a transport path along which the recording medium is transported, and that discharges air toward the transport path,
wherein the air discharge part includes
a housing that defines the air discharge part, the housing including a surface-perforated plate portion in which a plurality of ventilation holes for discharging air toward the transport path are formed, and
an air supply unit that supplies air to an inside of the housing through an air inlet formed in the housing, and
an internal pressure of the housing is made higher than an atmospheric pressure by the air supplied from the air supply unit, and the air is discharged toward the transport path through the ventilation holes of the surface-perforated plate portion.

2. The fixing device according to claim 1,
wherein the air discharge part includes an internal perforated plate that is disposed inside the housing to partition the inside of the housing into a front chamber on a surface-perforated plate portion side and a rear chamber on a side opposite to the front chamber, and in which a plurality of ventilation holes are formed, and the ventilation holes in at least a part of the internal perforated plate are disposed at positions different from positions of the ventilation holes of the surface-perforated plate portion, and
the air inlet is formed to open to the rear chamber.

3. The fixing device according to claim 2,
wherein a distance between the surface-perforated plate portion and the internal perforated plate is narrower than a distance between the internal perforated plate and a bottom surface of the housing that faces the internal perforated plate.

4. The fixing device according to claim 2,
wherein the ventilation holes of the surface-perforated plate portion and the ventilation holes of the internal perforated plate are circular, and a diameter of the ventilation holes of the internal perforated plate is larger than a diameter of the ventilation holes of the surface-perforated plate portion.

5. The fixing device according to claim 3,
wherein the ventilation holes of the surface-perforated plate portion and the ventilation holes of the internal perforated plate are circular, and a diameter of the ventilation holes of the internal perforated plate is larger than a diameter of the ventilation holes of the surface-perforated plate portion.

6. The fixing device according to claim 2,
wherein the ventilation holes of the surface-perforated plate portion are circular, the ventilation holes of the internal perforated plate are slit-shaped, and the ventilation holes of the internal perforated plate are disposed such that positions of the ventilation holes do not overlap the positions of the ventilation holes of the surface-perforated plate portion.

7. The fixing device according to claim 3,
wherein the ventilation holes of the surface-perforated plate portion are circular, the ventilation holes of the internal perforated plate are slit-shaped, and the ventilation holes of the internal perforated plate are disposed such that positions of the ventilation holes do not overlap the positions of the ventilation holes of the surface-perforated plate portion.

8. The fixing device according to claim 3,
wherein the ventilation holes of the surface-perforated plate portion and the ventilation holes of the internal perforated plate are circular, the surface-perforated plate portion and the internal perforated plate are plate members having an identical shape, and the ventilation holes of the surface-perforated plate portion and the ventilation holes of the internal perforated plate are located at different positions by shifting positions of the surface-perforated plate portion and the internal perforated plate or by changing orientations of the surface-perforated plate portion and the internal perforated plate.

9. The fixing device according to claim 2,
wherein an amount of air supplied to a region of the rear chamber corresponding to an area where a passing frequency of the recording medium is low is greater than in a case where the same amount of air is uniformly supplied throughout the rear chamber.

10. The fixing device according to claim 2,
wherein the air inlet formed in the housing is formed at a position, which corresponds to an area where a passing frequency of the recording medium is low, on a bottom surface of the housing that faces the internal perforated plate.

11. The fixing device according to claim 2,
wherein the air discharge part includes a rear chamber partition plate that is disposed in the rear chamber to partition the rear chamber into a rear anterior chamber on an internal perforated plate side and a rear posterior chamber on a side opposite to the rear anterior chamber, and in which a plurality of ventilation holes are formed, and
an opening ratio of the ventilation holes of the rear chamber partition plate is higher in a region corresponding to an area where a passing frequency of the recording medium is low than in a region corresponding to an area where a passing frequency of the recording medium is high.

12. The fixing device according to claim 2, further comprising:
a heat sink member that brings the surface-perforated plate portion and the internal perforated plate into thermal contact with each other in a region corresponding to an area where a passing frequency of the recording medium is low.

13. The fixing device according to claim 1,
wherein the surface-perforated plate portion is made of aluminum.

14. The fixing device according to claim 13,
wherein a reflectance of a surface of the surface-perforated plate portion that faces the heating part is 80% or more.

15. The fixing device according to claim 1,
wherein the air discharge part includes a dispersion plate that is disposed parallel with the surface-perforated plate portion inside the housing and that disperses and supplies the air supplied from the air supply unit to a surface of the surface-perforated plate portion on a side opposite to the transport path.

16. The fixing device according to claim 1, further comprising:
a main heating part that heats and presses the recording medium after the heating by the heating part to fix the unfixed image.

17. The fixing device according to claim 2, further comprising:
a main heating part that heats and presses the recording medium after the heating by the heating part to fix the unfixed image.

18. A recording medium floating device comprising:
a housing that is disposed at a position facing a heater heating, in a non-contact manner, a surface of a recording medium on which an unfixed image is formed across a transport path of the recording medium, the recording medium being grasped at a leading edge and transported, and that includes a surface-perforated plate portion in which a plurality of ventilation holes for discharging air toward the transport path are formed; and
an air supply unit that supplies air to an inside of the housing through an air inlet formed in the housing,
wherein an internal pressure of the housing is made higher than an atmospheric pressure by the air supplied from the air supply unit, and the air is discharged toward the transport path through the ventilation holes of the surface-perforated plate portion.

19. The recording medium floating device according to claim 18,
wherein the recording medium floating device includes an internal perforated plate that is disposed inside the housing to partition the inside of the housing into a front chamber on a surface-perforated plate portion side and a rear chamber on a side opposite to the front chamber, and in which a plurality of ventilation holes are formed, and the ventilation holes in at least a part of the internal perforated plate are disposed at positions different from positions of the ventilation holes of the surface-perforated plate portion, and
the air inlet is formed to open to the rear chamber.
